(19) United States
(12) Patent Application Publication
(10) Pub. No.: US 2025/0165808 A1
(43) Pub. Date: May 22, 2025

(54) SOLUTION-DETERMINATION SYSTEM

(71) Applicant: NEC Corporation, Minato-ku, Tokyo (JP)

(72) Inventor: Ryutaro DOI, Tokyo (JP)

(73) Assignee: NEC Corporation, Minato-ku, Tokyo (JP)

(21) Appl. No.: 18/840,957

(22) PCT Filed: Mar. 22, 2022
(86) PCT No.: PCT/JP2022/013284

§ 371 Date: Aug. 23, 2024

(51) Int. Cl. G06N 5/01

(52) U.S. Cl. CPC G06N 5/01

(57) ABSTRACT

A solution-determination system 100 of the present invention includes: a plurality of optimization processing units 121 that perform solution-determination of a single optimization problem by neighborhood search; and a selection unit that identifies a first optimization processing unit which is at least one optimization processing unit, and second optimization processing units which are another plurality of optimization processing units, and selects some optimization processing units of the second optimization processing units as alteration-target optimization processing units whose search areas are to be altered, on the basis of solutions determined at the respective optimization processing units.

### TECHNICAL FIELD

The present invention relates to a solution-determination system, a solution-determination method, and a solution-determination program.

### BACKGROUND ART

Combinatorial optimization problems mean problems to find the best combination suited for a purpose from an enormous amount of choices, and it has been known that diverse tasks in the real world related to logistics planning, digital marketing, drug discovery, and the like can be expressed as combinatorial optimization problems. Combinatorial optimization problems can be modeled as problems to search for a solution with the best evaluation value based on some measure when a large number of solution candidates are given. For example, in logistics planning, there is a combinatorial optimization problem to search for a transport route with the shortest total travel distance or transportation time from a large number of transport routes.

SA (Simulated Annealing) is one of typical approximate methods for combinatorial optimization problems. SA is an approach to searching a solution space by repeating transitions to neighborhood solutions obtained by partially changing current solutions using a random initial solution as a start point, to find a solution with the best evaluation value. In a case where an evaluation value of a neighborhood solution is better than an evaluation value of a current solution, a transition to the neighborhood solution is necessarily made, and a transition is made probabilistically also in a case where the evaluation value is bad, thereby making it possible to reach a global optimal solution without falling into a local optimal solution. Here, a state of solution-determination by SA is explained using an example depicted in FIG. 1. First, a search is started from a random initial solution P1. Thereafter, generation of and a transition (solid arrow) to a neighborhood solution lead to a local optimal solution P2. Furthermore, due to the probabilistic transition (dotted arrow) that is made in a case where the evaluation value worsens, the transition is made out from the local optimal solution P2 through a solution P3 to a solution 4. Then, a global optimal solution P6 with the best evaluation value is reached in the end.

On the other hand, because many combinatorial optimization problems are classified as NP-hard problems, and because, as the scale of a problem increases, the number of solution candidates involved therein increases explosively, it becomes difficult to find optimal solutions in a realistic length of time. One possible approach to coping with this is to execute a plurality of instances of SA in parallel. In this case, since the respective instances of SA start searches from different initial solutions, the respective instances of SA also reach different solutions in the end. In view of this, by adopting a solution of an instance of SA with the best evaluation value in the end, it can be expected to enhance the solution precision as compared with a case where a search is performed by a single instance of SA.

Here, an approach to executing a plurality of instances of SA in parallel is described in Patent Literature 1. According to Patent Literature 1, in a case where a plurality of solution-search units adopt mutually different search algorithms, they implement cooperative operations. Specifically, according to Patent Literature 1, the respective solution-search units are caused to operate asynchronously, and the best solution of solutions obtained by all the solution-search units is kept stored. Each solution-search unit compares its own solution and the best solution during optimization, and, in a case where they are different, replaces its own solution with the best solution. Thereafter, the respective solution-search units continue the optimization again, and repeat the operation.

### CITATION LIST

### Patent Literature

Patent Literature 1: JP 2021-144443 A.

### SUMMARY OF INVENTION

### Technical Problem

However, because searches are performed concentratedly around the best solution using all optimization devices in the approach according to Patent Literature 1 mentioned above, the best solution at a certain time point is a solution which is good when seen locally; however, there is a fear that, in a case where a global optimal solution is positioned at a distance in a solution space, the searches performed by all the optimization devices are concentrated around a local solution distant from the optimal solution. This results in a problem that an optimal solution cannot be determined fast and precisely.

Because of this, an object of the present invention is to provide a solution-determination system that can solve a problem mentioned above that a solution of an optimization problem cannot be determined fast and precisely in a case where a plurality optimization devices that execute neighborhood searches are caused to operate.

### Solution to Problem

A solution-determination system according to an aspect of the present invention includes:

a plurality of optimization processing units that perform solution-determination of a single optimization problem by neighborhood search; and

a selection unit that identifies a first optimization processing unit which is at least one optimization processing unit, and second optimization processing units which are another plurality of optimization processing units, and selects some optimization processing units of the second optimization processing units as alteration-target optimization processing units whose search areas are to be altered, on the basis of solutions determined at the respective optimization processing units.

In addition, a solution-determination method according to an aspect of the present invention is a solution-determination method performed by a solution-determination system including a plurality of optimization processing units that perform solution-determination of a single optimization problem by neighborhood search, the solution-determination method including:

identifying a first optimization processing unit which is at least one optimization processing unit, and second optimization processing units which are another plurality of optimization processing units on the basis of solutions determined at the respective optimization processing units; and

selecting some optimization processing units of the second optimization processing units as alteration-target optimization processing units whose search areas are to be altered, on the basis of the solutions determined at the respective optimization processing units.

In addition, a program according to an aspect of the present invention causes an information processing device including a plurality of optimization processing units that perform solution-determination of a single optimization problem by neighborhood search to execute processes of:

identifying a first optimization processing unit which is at least one optimization processing unit, and second optimization processing units which are another plurality of optimization processing units on the basis of solutions determined at the respective optimization processing units; and

selecting some optimization processing units of the second optimization processing units as alteration-target optimization processing units whose search areas are to be altered, on the basis of the solutions determined at the respective optimization processing units.

### Advantageous Effects of Invention

By being configured in the manners above, the present invention makes it possible to determine a solution of an optimization problem fast and precisely in a case where a plurality optimization devices that execute neighborhood searches are caused to operate.

### BRIEF DESCRIPTION OF DRAWINGS

FIG. 1 is a figure depicting an example of an approximate method for an optimization problem.

FIG. 2 is a block diagram depicting the configuration of a solution-determination system according to a first example embodiment of the present invention.

FIG. 3 is a flowchart depicting an operation performed by the solution-determination system disclosed in FIG. 2.

FIG. 4A is a figure depicting an example of a solution-determination process performed by the solution-determination system disclosed in FIG. 2.

FIG. 4B is a figure depicting an example of the solution-determination process performed by the solution-determination system disclosed in FIG. 2.

FIG. 5A is a figure depicting an example of a solution-determination process performed by the solution-determination system disclosed in FIG. 2.

FIG. 5B is a figure depicting an example of a solution-determination process performed by the solution-determination system disclosed in FIG. 2.

FIG. 5C is a figure depicting an example to be compared with the solution-determination processes performed by the solution-determination system disclosed in FIG. 2.

FIG. 6 is a figure depicting an example of a process of generating a new search area performed by the solution-determination system disclosed in FIG. 2.

FIG. 7 is a figure depicting an example of a process of generating a new search area performed by the solution-determination system disclosed in FIG. 2.

FIG. 8 is a block diagram depicting the hardware configuration of a solution-determination system according to a second example embodiment of the present invention.

FIG. 9 is a block diagram depicting the configuration of the solution-determination system according to the second example embodiment of the present invention.

FIG. 10 is a flowchart depicting an operation performed by the solution-determination system according to the second example embodiment of the present invention.

### DESCRIPTION OF EMBODIMENTS

### First Example Embodiment

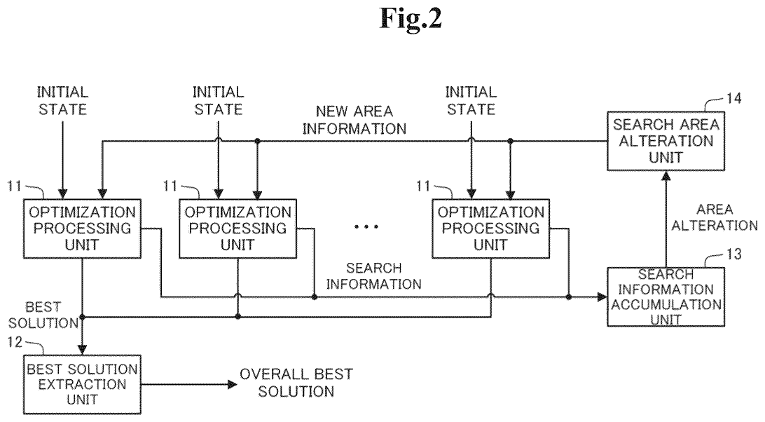

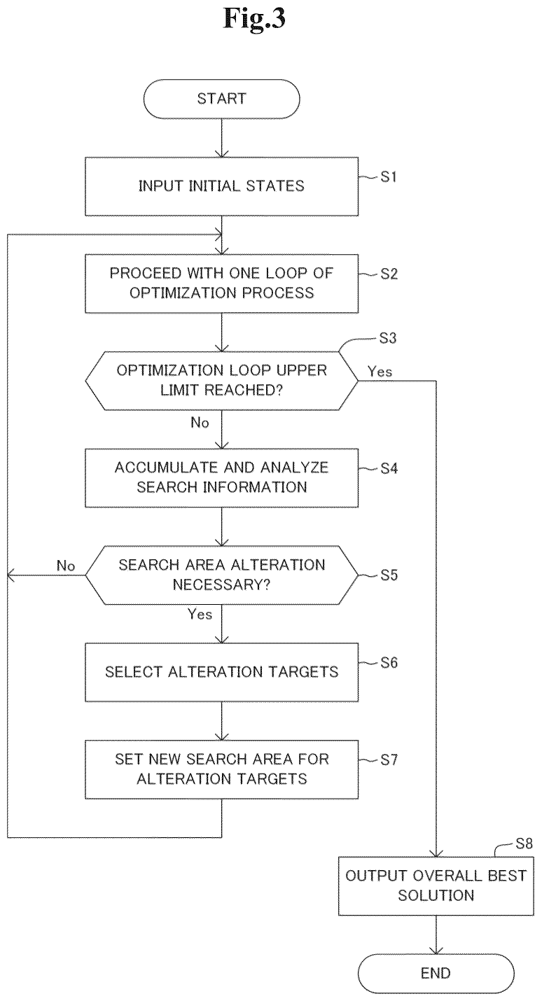

A first example embodiment of the present invention is explained with reference to FIG. 2 to FIG. 7. FIG. 2 is a figure for explaining the configuration of a solution-determination system, and FIG. 3 to FIG. 7 are figures for explaining processing operations performed by the solution-determination system.

### [Configuration]

The solution-determination system according to the present invention is a system having a function to determine a solution of a combinatorial optimization problem which is a problem to find the best combination suited for a purpose from an enormous amount of choices. For example, the solution-determination system is used in a case where, in logistics planning, a solution of an optimization problem like a transport route with the shortest total travel distance or transportation time from a large number of transport routes is searched for. It should be noted that the solution-determination system may be used for determining a solution of an optimization problem in any field such as digital marketing or drug discovery.

The solution-determination system includes one or more information processing devices including an arithmetic device and a storage device. Then, as depicted in FIG. 2, the solution-determination system includes a plurality of optimization processing units 11, a best solution extraction unit 12, a search information accumulation unit 13, and a search area alteration unit 14. The plurality of optimization processing units 11, the best solution extraction unit 12, the search information accumulation unit 13, and the search area alteration unit 14 can be realized by execution, by the arithmetic device, of programs for realizing respective functions stored on the storage device. Note that the number of the optimization processing units 11 illustrated in FIG. 2 is only three, but the number is not limited to three. Any number of optimization processing units 11 may be provided. Hereinbelow, each configuration is mentioned in detail.

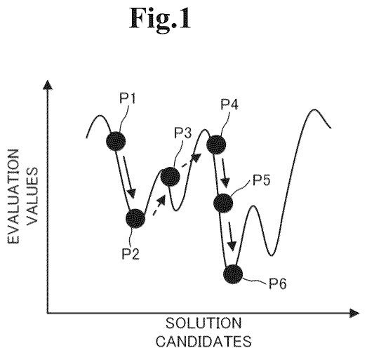

Each optimization processing unit 11 has a function to receive inputs of a randomly-set initial solution, and a solution evaluation value function, and optimize a solution of a combinatorial optimization problem whose solution should be determined according to a neighborhood search algorithm. As an example, the optimization processing unit 11 optimizes a solution of an optimization problem according to an algorithm of SA (Simulated Annealing) explained in the description above with reference to FIG. 1. Note that, in the present example embodiment, the method of expressing an initial solution and an evaluation value function therefor input to the optimization processing unit 11 is any method, and may be an expression method unique to a combinatorial optimization problem whose solution should be determined or may be the Ising model or QUBO (Quadratic Unconstrained Binary Optimization) that can generally express a large number of combinatorial optimization problems. In addition, the optimization processing unit 11 may additionally receive an input of constraints in a combinatorial optimization problem whose solution should be determined. Then, the neighborhood search algorithm used at the optimization processing unit 11 is not necessarily SA mentioned above, but may be any algorithm such as Tabu search or hill climbing. Note that the optimization processing unit 11 may perform a neighborhood search process, that is, a solution-determination process, in parallel with other optimization processing units 11.

Each optimization processing unit 11 implements generation of a neighborhood solution and determination as to whether to or not to make a transition to the neighborhood solution every time the optimization processing unit 11 implements one loop which is one unit of the solution-determination process. Along with this, the optimization processing unit 11 evaluates the determined solution on the basis of the solution. For example, on the basis of the determined solution, the optimization processing unit 11 calculates an evaluation value using the evaluation value function mentioned above or calculates, using a preset calculation formula, the degree of fulfillment representing the degree to which set constraints are fulfilled. Then, during a search, the optimization processing unit 11 transmits, to the search information accumulation unit 13, information obtained during the course of the search, that is, information such as the determined solution, its evaluation value, the degree of fulfillment regarding constraints, or the number of performed loops. Note that the optimization processing unit 11 may transmit, to the search information accumulation unit 13, information obtained during the course of the search at any timing such as after each loop, after a predetermined number of performed loops, or according to a request from the search information accumulation unit 13.

In addition, in a case where each optimization processing unit 11 has received new search area information from the search area alteration unit 14 as described later, the optimization processing unit 11 alters its search area to the received new search area information, and thereafter continues the optimization process. In addition, in a case where the optimization process is completed when the number of loops has reached a set upper limit value, an evaluation value fulfills a criterion, and so on, the optimization processing unit 11 transmits, to the best solution extraction unit 12, a solution with the best evaluation value obtained during the course of the search.

The best solution extraction unit 12 compares the respective best solutions received from the respective optimization processing units 11, and outputs a solution with the best evaluation value as the overall best solution.

The search information accumulation unit 13 (search area alteration unit) analyzes search information collected from the optimization processing units 11, and determines whether or not it is necessary to alter the search areas. That is, the search information accumulation unit 13 determines timings when search areas are to be altered on the basis of the search information. Then, the search information accumulation unit 13 transmits an area alteration start signal and the search information to the search area alteration unit 14 in a case where it is necessary to alter the search areas. Here, for example, examples of the search information that the search information accumulation unit 13 collects from each optimization processing unit 11 include the best solution obtained up to that point, its evaluation value, the degree of fulfillment regarding constraints, the number of performed loops of the optimization process, and the like. It should be noted that the search information is not limited to the information mentioned above, but any information obtained during the course of the search can be search information.

For example, the search information accumulation unit 13 determines to alter search areas regularly every time a predetermined number of loops has been performed. As an example, the search information accumulation unit 13 determines to alter search areas every time ten loops have been performed. In this manner, the search information accumulation unit 13 may determine to alter search areas on the basis of the progress status of the solution-determination process performed by the optimization processing units 11. In addition, the search information accumulation unit 13 may determine to alter search areas dynamically on the basis of the states of all the optimization processing units 11. In this case, the search information accumulation unit 13 uses a statistic of search information collected from the optimization processing units 11. For example, the search information accumulation unit 13 observes a statistic of evaluation values of solutions of all the optimization processing units 11, and, in a case where the statistic of the evaluation values of the solutions exceeds a threshold, determines that search area alterations are necessary, and determines to alter search areas. Note that the statistic here means the average, median, maximum value, minimum value, dispersion, standard deviation, or the like of the evaluation values of the solutions. In this manner, the search information accumulation unit 13 may determine to alter the search areas on the basis of evaluation of solutions determined at the respective optimization processing units. It should be noted that the method mentioned above performed by the search information accumulation unit 13 of determining timings when search areas are to be altered is an example, and such timings may be determined by any method.

When the search area alteration unit 14 (selection unit, search area alteration unit) receives an area alteration start signal transmitted from the search information accumulation unit 13 as mentioned above, the search area alteration unit 14 alters the search areas of the optimization processing units 11 by performing the following four processes. Specifically, the four processes performed by the search area alteration unit 14 are: a process of identifying optimization processing units with high search efficiency (first optimization processing units) (first process); a process of selecting search-area alteration-target optimization processing units (alteration-target optimization processing units) from optimization processing units other than the optimization processing units with high search efficiency (second process); a process of determining a new search area on the basis of the states of the optimization processing units with high search efficiency (third process); and a process of transmitting the new search area to the alteration-target optimization processing units 11 (fourth process).

In the first process, optimization processing units 11 that are deemed to have high search efficiency (first optimization processing units) are identified on the basis of solutions determined by the respective optimization processing units 11. As an example, in the first process, optimization processing units 11 that are determined, on the basis of a preset criterion, as having high evaluation values of solutions, having high degrees of fulfillment regarding constraints, or having superior comprehensive evaluation values considering both the evaluation values and the degrees of fulfillment are identified as optimization processing units with high search efficiency. At this time, in the first process, one optimization processing unit 11 with the highest search efficiency may be identified, or a plurality of optimization processing units 11 with the highest search efficiency may be identified. Note that identifying optimization processing units with high search efficiency in this manner results in identifying the other remaining optimization processing units 11 as optimization processing units 11 that are deemed to have low search efficiency (second optimization processing units). In particular, as mentioned above, preferably, identifying a small number of optimization processing units 11 such as one optimization processing unit 11 with the highest search efficiency or a plurality of optimization processing units 11 with the best search efficiency from a plurality of optimization processing units 11 results in identification of a plurality of optimization processing units 11 with low search efficiency which are greater in number than the optimization processing units 11 with the best search efficiency.

In the second process, optimization processing units 11 whose search areas should be altered are selected from the optimization processing units 11 with low search efficiency identified in the first process. At this time, in the second process, a statistic of accumulated information collected from the optimization processing units 11 with low search efficiency, for example, a statistic (average, median, maximum value, minimum value, dispersion, standard deviation, etc.) of evaluation values of solutions, degrees of fulfillment regarding constraints, or the like, is used to select the optimization processing units 11. As an example, in the second process, the average of evaluation values of solutions of all the optimization processing units 11 identified as having low search efficiency is evaluated, and optimization processing units 11 with evaluation values worse than the average by a preset amount or more are selected as alteration targets. In addition, as another example, in the second process, the deviations of degrees of fulfillment regarding constraints of solutions of all the optimization processing units 11 identified as having low search efficiency are computed, and optimization processing units 11 with deviations which are worse than a threshold are selected as alteration targets. In particular, in the second process unit, not all the optimization processing units in the plurality of optimization processing units 11 with low search efficiency, but one or more optimization processing units 11 which are some of them are selected as optimization processing units 11 whose search areas should be altered. It should be noted that optimization processing units 11 whose search areas should be altered are not necessarily selected by the method mentioned above, but may be selected by another method.

In the third process, a new search area for the optimization processing units 11 selected in the second process is determined on the basis of the states of the optimization processing units 11 with high search efficiency identified in the first process. Here, the new search area means a new solution. For example, examples of an approach to determining a new solution in the third process include: an approach in which a solution of an optimization processing unit 11 with the highest search efficiency in the optimization processing units 11 identified in the first process is treated as a new solution as it is; an approach in which a solution obtained by partially and randomly changing the solution of the optimization processing unit 11 with the highest search efficiency is treated as a new solution; an approach in which a plurality of solutions of a plurality of optimization processing units 11 with high search efficiency are combined to generate a new solution; and the like. It should be noted that the approaches to determining a new solution in the third process mentioned above are examples, and another approach may be used.

In the fourth process, the new solution determined in the third process is transmitted to the optimization processing units 11 selected in the second process. The current solutions of the search-area alteration-target optimization processing units 11 are overwritten with the new solution. Here, neighborhood search algorithms represented by SA can realize alterations of search areas by overwriting current solutions in order to search for neighborhood solutions obtained by changing parts of the current solutions. Note that the overwriting of solutions of the respective alteration-target optimization processing units 11 may additionally reflect a probabilistic behavior. That is, the overwriting may be performed directly at a preset probability p, or the overwriting of the alteration targets may be skipped (may be not performed) at the probability (1-p). This probabilistic behavior creates a possibility that it is possible to avoid overwriting of a solution of an optimization processing unit 11 whose current solution is not so good, but is to lead to a very good solution after the further continuation of its search.

### Operations

Next, an operation performed by the solution-determination system mentioned above is explained mainly with reference to a flowchart in FIG. 3. First, the solution-determination system inputs a randomly-set initial solution to each of the respective optimization processing units 11 (step S1). Then, the solution-determination system proceeds with one loop of an optimization process according to a neighborhood search algorithm at the optimization processing units 11 (step S2). For example, one loop in SA means generation of a neighborhood solution, computation of an evaluation value of the neighborhood solution, determination as to whether to or not to make a transition to the neighborhood solution, and the transition. Note that, in order to avoid a situation where completely identical searches are performed at a plurality of optimization processing units 11, mutually different initial solutions may be input to the respective optimization processing units 11 at step S1, and/or mutually different random number sequences may be used at the respective optimization processing units 11 at step S2.

Thereafter, the solution-determination system performs a process at a conditional branch according to the number of optimization loops that have been performed up to that point (step S3). For example, in a case where the number of optimization loops that have been performed up to that point has reached a set upper limit (Yes at step S3), the solution-determination system collects the best solutions of the respective optimization processing units 11 in the best solution extraction unit 12, and outputs the overall best solution (step S8). On the other hand, in a case where the number of optimization loops that have been performed up to that point has not reached the set upper limit (No at step S3), the solution-determination system transmits, to the search information accumulation unit 13, search information obtained by searches having been performed by the optimization processing units 11 up to that point. Examples of the search information include the best solutions obtained up to that point, their evaluation values, degrees of fulfillment regarding constraints, the number of performed loops of the optimization process, and the like.

Then, the solution-determination system performs analysis using the search information accumulated in the search information accumulation unit 13 (step S4), and determines whether or not it is necessary to alter the search areas of the optimization processing units 11 (step S5). For example, the solution-determination system may statically determine timings of search area alterations, and, for example, may alter search areas every time ten loops of the optimization process have been performed. Alternatively, the solution-determination system may dynamically determine timings of search area alterations on the basis of the states of the optimization processing units 11. For example, the solution-determination system may observe the dispersion of solutions of all the optimization processing units 11, and determine to alter search areas in a case where the dispersion exceeds a threshold, or alternatively may alter search areas in a case where the difference between the best evaluation value and the worst evaluation value has exceeded a threshold.

In a case where it is necessary to alter search areas (Yes at step S5), the solution-determination system selects optimization processing unit 11 whose search areas need to be altered (step S6), and alters the search areas of the optimization processing units 11 to a new search area (step S7). Specifically, in the first process described above, the solution-determination system identifies optimization processing units 11 with evaluation values of solutions which are better than other optimization processing units 11. Then, in the second process described above, the solution-determination system compares evaluation values of solutions of all the other optimization processing units 11 than the optimization processing units 11 identified as having evaluation values of solutions which are determined as being good, and selects, as search-area alteration targets, optimization processing units 11 with the lowest evaluation values or the like. Next, in the third process described above, the solution-determination system determines, as a new search area, that is, as a new solution, a solution which is identical to or is obtained by altering a solution of an optimization processing unit 11 identified as having an evaluation value of a solution which is determined as being good. Last, in the fourth process described above, the solution-determination system transmits the new solution determined in the third process to the optimization processing units 11 selected in the second process, and overwrites the solutions of the optimization processing units 11 with the new solution.

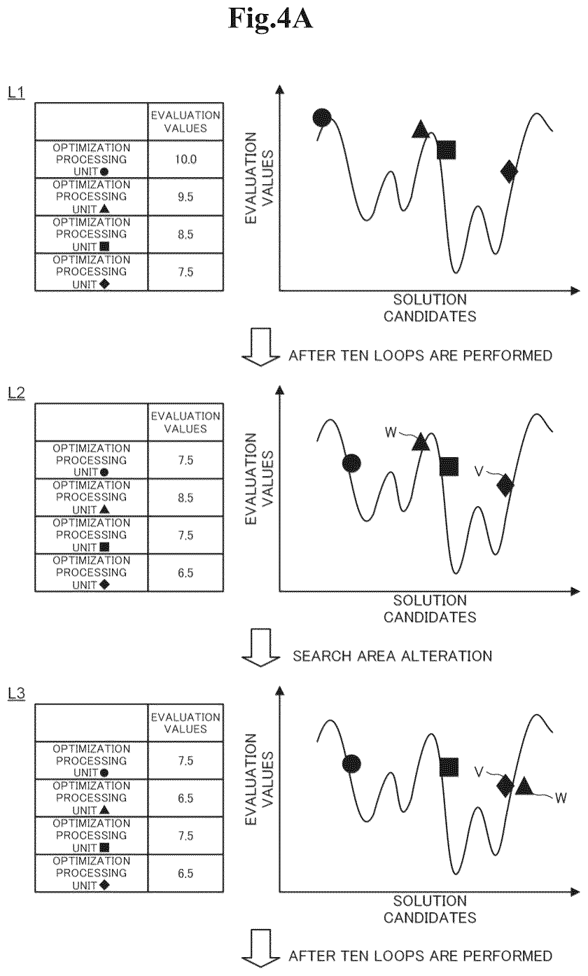

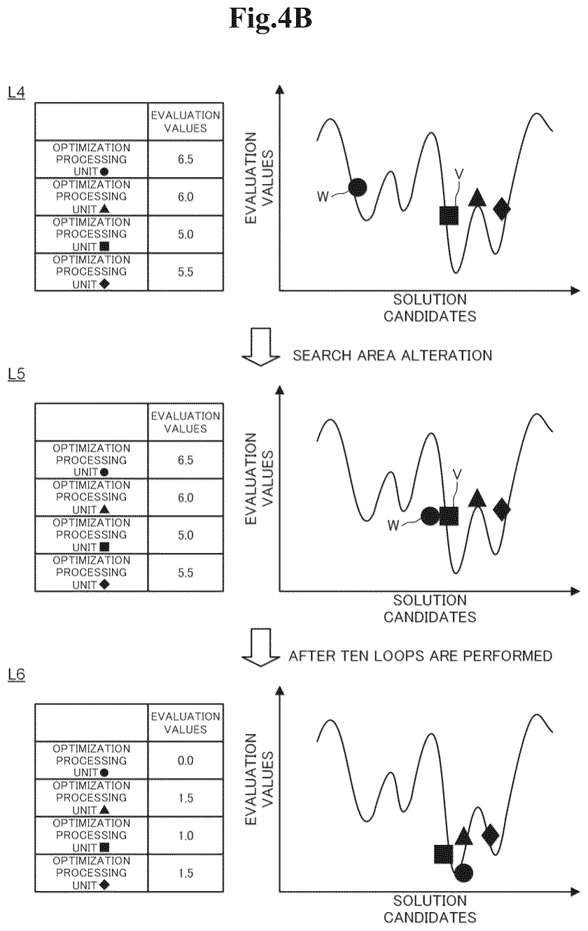

Next, a specific example of the operation performed by the solution-determination system mentioned above is explained with reference to FIG. 4A and FIG. 4B. Note that, according to settings assumed in FIG. 4, as an example, every time ten loops of optimization are performed, a solution of an optimization processing unit 11 with the top evaluation value is copied to a solution of an optimization processing unit 11 with the lowest evaluation value. In addition, FIG. 4 depicts an example in which four optimization processing units 11 labeled with symbols “●, ▴, ▪, ♦” operate cooperatively while sharing search information. Then, regarding each timing denoted with one of reference numerals L1 to L6 in FIG. 4, the figure on the left depicts evaluation values of solutions of the respective optimization processing units 11, and the figure on the right depicts the positional relationship among the solutions of the respective optimization processing units 11 in a solution evaluation value function. Note that it is assumed here that the lower an evaluation value of a solution is, the more highly the solution is evaluated, and the better the solution is.

First, as represented by a state denoted with the reference numeral L1 in FIG. 4A, a randomly-set initial solution is input to each optimization processing unit 11. Thereafter, after ten loops of optimization are performed at each optimization processing unit 11, a state denoted with the reference numeral L2 is observed. At this time point, the optimization processing unit ♦ (V) has the best evaluation value (evaluation value 6.5), and the optimization processing unit ▴ (W) has the worst evaluation value (evaluation value 8.5). In view of this, as represented by a state denoted with the reference numeral L3, a solution of the optimization processing unit ♦ (V) is copied to a solution of the optimization processing unit ▴ (W). This results in an alteration of the search area of the optimization processing unit ▴.

Thereafter, when another ten loops of optimization is performed, a state denoted with the reference numeral L4 in FIG. 4B is observed. Note that, because the optimization processing unit ♦ and the optimization processing unit ▴ use different random number sequences, subsequent searches are different even if their states in the state denoted with the reference numeral L3 are identical. Then, at the time point denoted with the reference numeral L4, the optimization processing unit ▪ (V) has the best evaluation value, and the optimization processing unit ● (W) has the worst evaluation value. In view of this, as represented by a state denoted with the reference numeral L5, a solution of the optimization processing unit ▪ (V) is copied to a solution of the optimization processing unit ● (W), thereby altering the search area of the optimization processing unit ●. Thereafter, when another ten loops of optimization is performed, a state denoted with the reference numeral L6 is observed. In this example, the optimization processing unit ▪ reaches a global optimal solution, and the optimization ends.

As depicted in the specific example in FIG. 4A and FIG. 4B, it can be known that, in the solution-determination system according to the present invention, by causing optimization processing units 11 that operate in parallel to share search information during the course of a search, the search can be performed with resources that are allocated intensively for promising areas around an optimal solution.

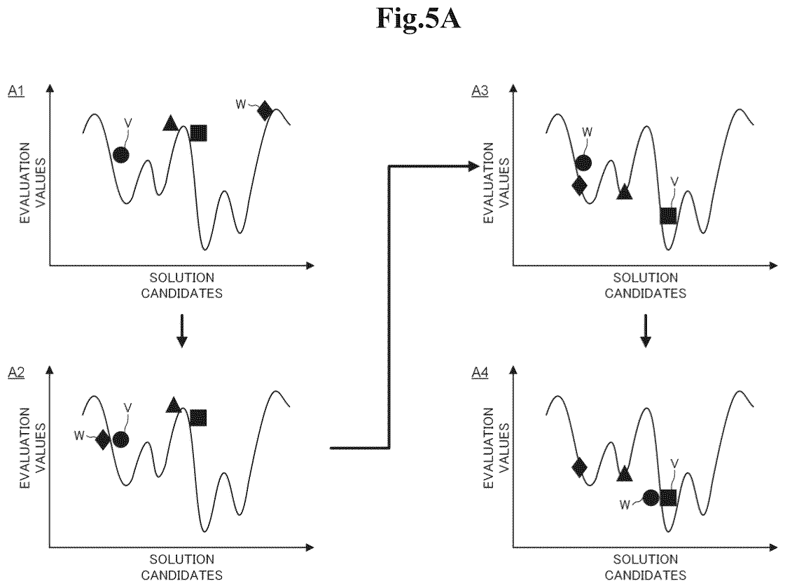

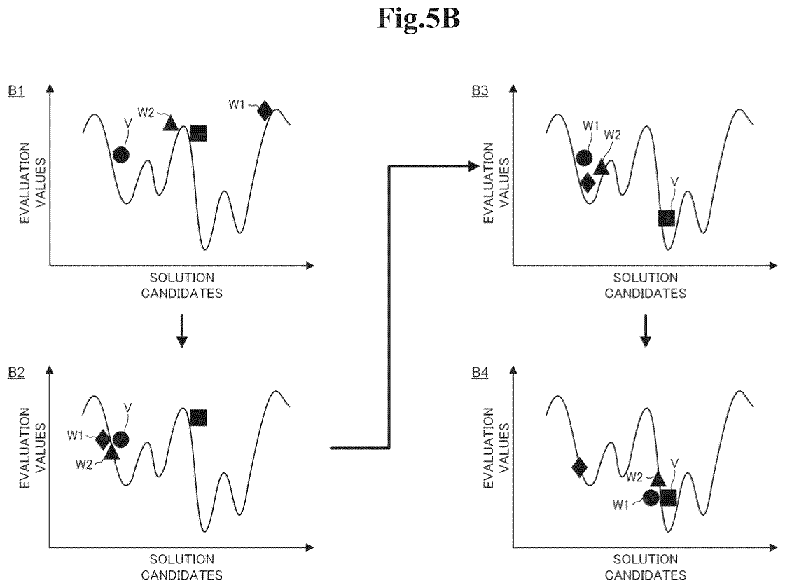

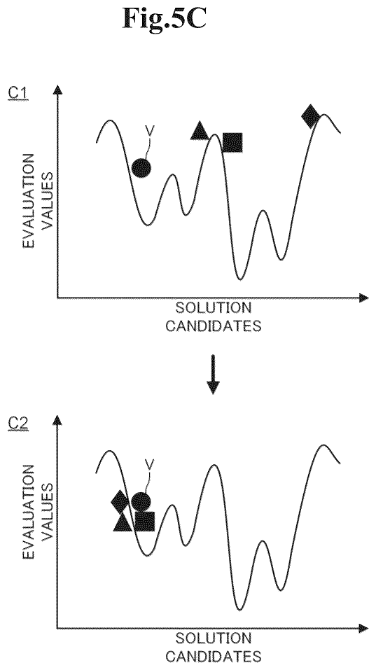

Next, an operation in the solution-determination system of the present invention, and an operation performed by a configuration different from the present invention are explained by comparing them. Both FIG. 5A and FIG. 5B depict operation examples of the present invention. FIG. 5A depicts an operation example in which there is one search-area alteration-target optimization processing unit 11, and FIG. 5B depicts an operation example in which there are a plurality of search-area alteration-target optimization processing units 11 (two search-area alteration-target optimization processing units 11 here). In addition, FIG. 5C depicts an operation example of a configuration different from the present invention.

Specifically, FIG. 5A depicts an operation example of a design in which a solution (V) of an optimization processing unit 11 having the top evaluation value is used to overwrite a solution (W) of an optimization processing unit 11 having the lowest evaluation value, and a state denoted with a reference numeral A1 changes to a state denoted with a reference numeral A4. FIG. 5B depicts an operation example of a design in which the solution (V) of the optimization processing unit 11 having the top evaluation value is used to overwrite solutions (W1, W2) of optimization processing units 11 having the two lowest evaluation values, and a state denoted with a reference numeral B1 changes to a state denoted with a reference numeral B4. FIG. 5C depicts, as a comparative example, an operation example of a design in which the solution (V) of the optimization processing unit 11 having the top evaluation value is used to overwrite solutions of all the other optimization processing units 11 than the optimization processing unit 11 having the top evaluation value.

First, it can be known from the operation in FIG. 5C which is the comparative example, that is, a state denoted with a reference numeral C2 having changed from a state denoted with a reference numeral C1, that search resources are concentrated around a local solution. In contrast, it can be known that searches are performed in dispersed search areas extending over a larger solution space in FIG. 5A and FIG. 5B depicting design examples of the present invention. That is, the present invention makes it possible to avoid a situation where search resources are excessively concentrated at local solutions. As a result, a solution of an optimization problem can be determined fast and precisely.

Note that it can be known from a comparison between FIG. 5A and FIG. 5B that the degrees of concentration/dispersion of searches are different. For example, a search is performed in search areas that are dispersed in a larger solution space in FIG. 5A; on the other hand, a search is performed in search areas that are concentrated in a smaller area in FIG. 5B. In this manner, the search area alteration unit 14 can flexibly select alteration targets using accumulated information of a plurality of optimization processing units 11 excluding an optimization processing unit with high search efficiency. In this manner, the present invention makes it possible to control the degree of concentration/dispersion of search resources, thereby making it possible to avoid a situation where search resources are excessively concentrated at local solutions. As a result, a solution of an optimization problem can be determined faster and more precisely.

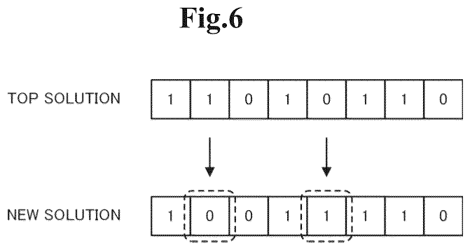

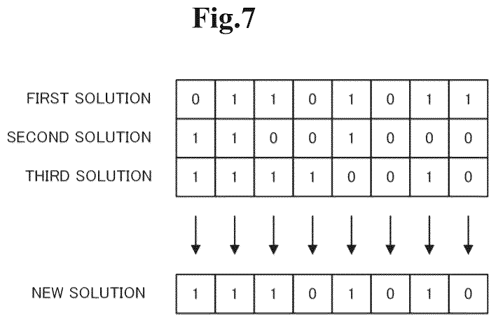

Note that whereas a solution of an optimization processing unit whose evaluation value of the solution is the top is used as a new search area to overwrite solutions of alteration-target optimization processing units 11 as it is in the example explained in the description above, a modification example of a new search area is explained. For example, examples of an approach to determining a new search area also include: an approach in which a solution obtained by partially and randomly changing a solution of an optimization processing unit 11 with the highest search efficiency is treated as a new solution; an approach in which solutions of a plurality of optimization processing units 11 with high search efficiency are combined to generate a new solution; and the like. An example of the former is illustrated in and explained with reference to FIG. 6, and an example of the latter is illustrated in and explained with reference to FIG. 7. Note that it is assumed in these examples that solution information includes a sequence of binary variables consisting of 0 and 1.

FIG. 6 depicts an example in which a new solution is generated by giving random fluctuations to parts of a solution with the best evaluation value. By inverting the values of randomly selected bits from 0 to 1 or from 1 to 0, an area around a good solution can be set as a new search area. In addition, FIG. 7 depicts an example in which a new solution is generated from solutions with the top three evaluation values on a bit-by-bit majority decision basis. Thereby, a pattern shared by good solutions can be taken into a new solution, and a solution different from the source top three solutions can be set as a new search area.

### Second Example Embodiment

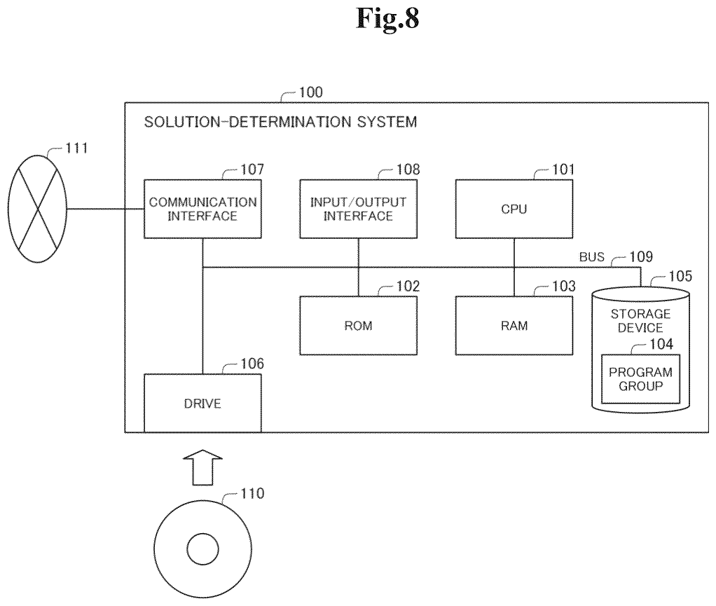

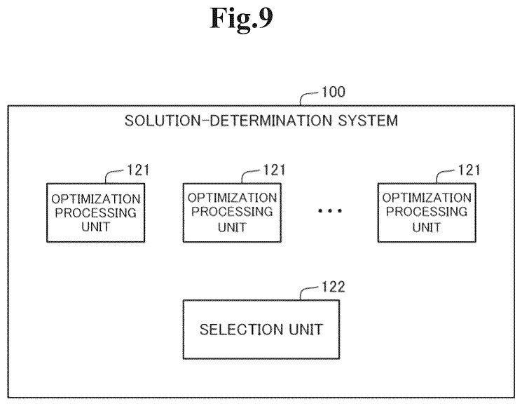

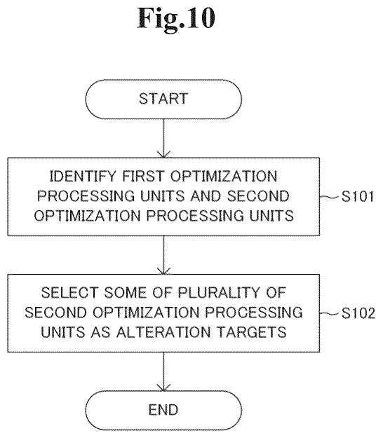

Next, a second example embodiment of the present invention is explained with reference to FIG. 8 to FIG. 10. FIG. 8 to FIG. 9 are block diagrams depicting the configuration of the solution-determination system in the second example embodiment, and FIG. 10 is a flowchart depicting an operation performed by the solution-determination system. Note that the present example embodiment illustrates outlines of the configurations of the solution-determination system and the solution-determination method explained in the example embodiment mentioned above.

First, the hardware configuration of a solution-determination system 100 in the present example embodiment is explained with reference to FIG. 8. The solution-determination system 100 is configured using a typical information processing device, and has a hardware configuration like the one below as an example.
Central Processing Unit (CPU) 101 (arithmetic device)
Read Only Memory (ROM) 102 (storage device)
Random Access Memory (RAM) 103 (storage device)
Program group 104 to be loaded to RAM 103
Storage device 105 having stored thereon the program group 104
Drive 106 that performs reading and writing on a storage medium 110 outside the information processing device
Communication interface 107 connected to a communication network 111 outside the information processing device
Input/output interface 108 for performing input/output of data
Bus 109 connecting the respective constituent elements.

Then, the solution-determination system 100 can construct and have optimization processing units 121 and a selection unit 122 depicted in FIG. 9 through acquisition of the program group 104 and execution thereof by the CPU 101. Note that the program group 104 is stored on, for example, the storage device 105 or the ROM 102 in advance, is loaded to the RAM 103 by the CPU 101, and is executed by the CPU 101 as needed. In addition, the program group 104 may be supplied to the CPU 101 via the communication network 111, or may be stored on the storage medium 110 in advance, read out by the drive 106, and supplied to the CPU 101. It should be noted that the optimization processing units 121 and the selection unit 122 mentioned above may be constructed using electronic circuits dedicated for realizing the means.

Note that FIG. 8 depicts an example of the hardware configuration of the information processing device that is the solution-determination system 100. The hardware configuration of the information processing device is not limited to that mentioned above. For example, the information processing device may be configured using part of the configuration mentioned above, such as without the drive 106.

Then, by functions of the optimization processing units 121 and the selection unit 122 constructed by programs as mentioned above, the solution-determination system 100 executes the solution-determination method depicted in the flowchart in FIG. 10.

As depicted in FIG. 10, the solution-determination system 100 executes processes of:

identifying a first optimization processing unit which is at least one optimization processing unit 121, and second optimization processing units which are another plurality of optimization processing units 121 on the basis of solutions determined at the respective optimization processing units 121 (step S101); and

selecting some optimization processing units 121 of the second optimization processing units as alteration-target optimization processing units whose search areas are to be altered (step S102).

By being configured in the manners described above, the present invention makes it possible to control the degree of concentration/dispersion of searches, thereby making it possible to avoid a situation where search resources are excessively concentrated at local solutions. As a result, a solution of an optimization problem can be determined faster and more precisely.

Note that the programs mentioned above can be supplied to a computer by being stored on a non-transitory computer readable medium of any type. Non-transitory computer readable media include tangible recording media (tangible storage media) of various types. Examples of non-transitory computer readable media include a magnetic recording medium (e.g. flexible disc, magnetic tape, hard disk drive), a magneto-optical recording medium (e.g. magneto-optical disc), a CD-ROM (Read Only Memory), a CD-R, a CD-R/W, and a semiconductor memory (e.g. mask ROM, PROM (Programmable ROM), EPROM (Erasable PROM), flash ROM, and RAM (Random Access Memory)). In addition, the programs may also be supplied to a computer by being stored on a transitory computer readable medium of any type. Examples of transitory computer readable media include electric signals, optical signals, and electromagnetic waves. A transitory computer readable medium can supply programs to a computer via a wired communication channel such as an electric wire or an optical fiber, or a wireless communication channel.

While the present invention has been explained thus far with reference to the example embodiments and the like described above, the present invention is not limited to the example embodiments mentioned above. The configurations and details of the present invention can be altered within the scope of the present invention in various manners that can be understood by those skilled in the art. In addition, at least one or more functions of the functions of the optimization processing units 121 and the selection unit 122 mentioned above may be executed at an information processing device installed and connected at any location on a network, that is, may be executed by so-called cloud computing.

### Supplementary Notes

Part of or the whole of the example embodiments described above can also be described as in the following supplementary notes. Hereinbelow, outlines of the configurations of a solution-determination system, a solution-determination method, and a program according to the present invention are explained. It should be noted that the present invention is not limited to the following configurations.

### (Supplementary Note 1)

A solution-determination system comprising:

a plurality of optimization processing units that perform solution-determination of a single optimization problem by neighborhood search; and

a selection unit that identifies a first optimization processing unit which is at least one optimization processing unit, and second optimization processing units which are another plurality of optimization processing units, and selects some optimization processing units of the second optimization processing units as alteration-target optimization processing units whose search areas are to be altered, on a basis of solutions determined at the respective optimization processing units.

### (Supplementary Note 2)

The solution-determination system according to supplementary note 1, wherein the selection unit identifies the first optimization processing unit and the second optimization processing units, and selects the alteration-target optimization processing units, on a basis of evaluation, using a preset criterion, of the solutions determined at the respective optimization processing units.

### (Supplementary Note 3)

The solution-determination system according to supplementary note 2, wherein the selection unit identifies, as the first optimization processing unit, an optimization processing unit whose solution is determined as being good by the evaluation using the preset criterion, and identifies another plurality of optimization processing units as the second optimization processing units.

### (Supplementary Note 4)

The solution-determination system according to supplementary note 2 or 3, wherein the selection unit selects the alteration-target optimization processing units on a basis of a result of comparison of the evaluation of a plurality of solutions, each of which is determined at one of a plurality of the optimization processing units identified as the second optimization processing units.

### (Supplementary Note 5)

The solution-determination system according to any one of supplementary notes 1 to 4, comprising a search area alteration unit that determines, as a new search area, a solution generated on a basis of a solution of the first optimization processing unit, and alters the search areas of the alteration-target optimization processing units to the new search area.

### (Supplementary Note 6)

The solution-determination system according to supplementary note 5, wherein the search area alteration unit determines, as the new search area, a solution generated on a basis of a plurality of solutions, each of which is determined at one of a plurality of the optimization processing units identified as the first optimization processing units.

### (Supplementary Note 7)

The solution-determination system according to supplementary note 6, wherein the search area alteration unit determines, as the new search area, a solution which is obtained by combining parts of a plurality of solutions, each of which is determined at one of a plurality of the optimization processing units identified as the first optimization processing units.

### (Supplementary Note 8)

The solution-determination system according to supplementary note 5, wherein the search area alteration unit determines, as the new search area, a solution which is obtained by partially altering a solution determined at one optimization processing unit identified as the first optimization processing unit.

### (Supplementary Note 9)

The solution-determination system according to any one of supplementary notes 5 to 8, wherein the search area alteration unit alters the search areas of the alteration-target optimization processing units to the new search area at a preset probability.

### (Supplementary Note 10)

The solution-determination system according to any one of supplementary notes 5 to 9, wherein the search area alteration unit determines a timing when the search areas of the alteration-target optimization processing units are to be altered, on a basis of a progress status of a solution-determination process performed by the optimization processing units.

### (Supplementary Note 11)

The solution-determination system according to any one of supplementary notes 5 to 10, wherein the search area alteration unit determines a timing when the search areas of the alteration-target optimization processing units are to be altered, on a basis of evaluation, using a preset criterion, of solutions determined at the respective optimization processing units.

### (Supplementary Note 12)

A solution-determination method performed by a solution-determination system including a plurality of optimization processing units that perform solution-determination of a single optimization problem by neighborhood search, the solution-determination method comprising:

identifying a first optimization processing unit which is at least one optimization processing unit, and second optimization processing units which are another plurality of optimization processing units on a basis of solutions determined at the respective optimization processing units; and

selecting some optimization processing units of the second optimization processing units as alteration-target optimization processing units whose search areas are to be altered, on the basis of the solutions determined at the respective optimization processing units.

(Supplementary Note 13)

A computer readable storage medium having stored thereon a program for causing an information processing device including a plurality of optimization processing units that perform solution-determination of a single optimization problem by neighborhood search to execute processes of:

identifying a first optimization processing unit which is at least one optimization processing unit, and second optimization processing units which are another plurality of optimization processing units on a basis of solutions determined at the respective optimization processing units; and

selecting some optimization processing units of the second optimization processing units as alteration-target optimization processing units whose search areas are to be altered, on the basis of the solutions determined at the respective optimization processing units.

### Reference Signs List

11: Optimization processing unit
12: Best solution extraction unit
13: Search information accumulation unit
14: Search area alteration unit
100: Solution-determination system
101: CPU
102: ROM
103: RAM
104: Program group
105: Storage device
106: Drive
107: Communication interface
108: Input/output interface
109: Bus
110: Storage medium
111: Communication network
121: Optimization processing unit
122: Selection unit

What is claimed is:

1. An information processing device comprising:
at least one memory configured to store instructions; and
at least one processor configured to execute instructions to:
cause a plurality of optimization processing units to execute solution-determination of a single optimization problem by neighborhood search; and
identify a first optimization processing unit which is at least one optimization processing unit, and second optimization processing units which are another plurality of optimization processing units, and select some optimization processing units of the second optimization processing units as alteration-target optimization processing units whose search areas are to be altered, on a basis of solutions determined at the respective optimization processing units.

2. The information processing device according to claim 1, wherein the at least one processor is configured to execute the instructions to identify the first optimization processing unit and the second optimization processing units, and select the alteration-target optimization processing units, on a basis of evaluation, using a preset criterion, of the solutions determined at the respective optimization processing units.

3. The information processing device according to claim 2, wherein the at least one processor is configured to execute the instructions to identify, as the first optimization processing unit, an optimization processing unit whose solution is determined as being good by the evaluation using the preset criterion, and identify another plurality of optimization processing units as the second optimization processing units.

4. The information processing device according to claim 2, wherein the at least one processor is configured to execute the instructions to select the alteration-target optimization processing units on a basis of a result of comparison of the evaluation of a plurality of solutions, each of which is determined at one of a plurality of the optimization processing units identified as the second optimization processing units.

5. The information processing device according to claim 1, wherein the at least one processor is configured to execute the instructions to determine, as a new search area, a solution generated on a basis of a solution of the first optimization processing unit, and alters the search areas of the alteration-target optimization processing units to the new search area.

6. The information processing device according to claim 5, wherein the at least one processor is configured to execute the instructions to determine, as the new search area, a solution generated on a basis of a plurality of solutions, each of which is determined at one of a plurality of the optimization processing units identified as the first optimization processing units.

7. The information processing device according to claim 6, wherein the at least one processor is configured to execute the instructions to determine, as the new search area, a solution which is obtained by combining parts of a plurality of solutions, each of which is determined at one of a plurality of the optimization processing units identified as the first optimization processing units.

8. The information processing device according to claim 5, wherein the at least one processor is configured to execute the instructions to determine, as the new search area, a solution which is obtained by partially altering a solution determined at one optimization processing unit identified as the first optimization processing unit.

9. The information processing device according to claim 5, wherein the at least one processor is configured to execute the instructions to alter the search areas of the alteration-target optimization processing units to the new search area at a preset probability.

10. The information processing device according to claim 5, wherein the at least one processor is configured to execute the instructions to determine a timing when the search areas of the alteration-target optimization processing units are to be altered, on a basis of a progress status of a solution-determination process performed by the optimization processing units.

11. The information processing device according to claim 5, wherein the at least one processor is configured to execute the instructions to determine a timing when the search areas of the alteration-target optimization processing units are to be altered, on a basis of evaluation, using a preset criterion, of solutions determined at the respective optimization processing units.

12. A solution-determination method performed by a solution-determination system including a plurality of optimization processing units that perform solution-determination of a single optimization problem by neighborhood search, the solution-determination method comprising:
identifying a first optimization processing unit which is at least one optimization processing unit, and second optimization processing units which are another plurality of optimization processing units on a basis of solutions determined at the respective optimization processing units; and
selecting some optimization processing units of the second optimization processing units as alteration-target optimization processing units whose search areas are to be altered, on the basis of the solutions determined at the respective optimization processing units.

13. A non-transitory computer readable storage medium having stored thereon a program for causing an information processing device including a plurality of optimization processing units that perform solution-determination of a single optimization problem by neighborhood search to execute processes of:
identifying a first optimization processing unit which is at least one optimization processing unit, and second optimization processing units which are another plurality of optimization processing units on a basis of solutions determined at the respective optimization processing units; and
selecting some optimization processing units of the second optimization processing units as alteration-target optimization processing units whose search areas are to be altered, on the basis of the solutions determined at the respective optimization processing units.

14. The solution-determination method according to claim 12, further comprising identifying the first optimization processing unit and the second optimization processing units, and selecting the alteration-target optimization processing units, on a basis of evaluation, using a preset criterion, of the solutions determined at the respective optimization processing units.

15. The solution-determination method according to claim 14, further comprising identifying, as the first optimization processing unit, an optimization processing unit whose solution is determined as being good by the evaluation using the preset criterion, and identifying another plurality of optimization processing units as the second optimization processing units.

16. The solution-determination method according to claim 15, further comprising selecting the alteration-target optimization processing units on a basis of a result of comparison of the evaluation of a plurality of solutions, each of which is determined at one of a plurality of the optimization processing units identified as the second optimization processing units.

17. The solution-determination method according to claim 12, further comprising determining, as a new search area, a solution generated on a basis of a solution of the first optimization processing unit, and altering the search areas of the alteration-target optimization processing units to the new search area.
